(19) United States
(12) Patent Application Publication
(10) Pub. No.: US 2008/0249800 A1
(43) Pub. Date: Oct. 9, 2008

(54) HEALTH CARE ECONOMICS MODELING SYSTEM

(76) Inventor: Murali M. Karamchedu, Beaverton, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 12/026,261

(22) Filed: Feb. 5, 2008

Related U.S. Application Data
(60) Provisional application No. 60/888,199, filed on Feb. 5, 2007.

(51) Int. Cl. G06Q 10/00; G06F 17/30

(52) U.S. Cl. 705/2

(57) ABSTRACT

Embodiments of the present invention provide systems and methods for electronically managing health care rate exhibits, the method comprising receiving standardized fee schedules for a plurality of health related services, and creating rate exhibits from the received standardized fee schedule. Other embodiments may be described and claimed.

### CROSS REFERENCE TO RELATED APPLICATIONS

The present application claims priority to U.S. Provisional Patent Application No. 60/888,199, filed Feb. 5, 2007, entitled “HEALTH CARE ECONOMICS MODELING SYSTEM,” the entire disclosure of which is hereby incorporated by reference in its entirety.

### TECHNICAL FIELD

Embodiments of the present invention relate to the field of health care economics, and more particularly, to methods and systems for health care economics modeling system.

### BACKGROUND

There are numerous doctors and health care organizations that provide different types of health care services to individuals. As there are numerous doctors and health care organizations, there are also numerous types of health insurance providers. The insurance coverage may include reimbursement for whole or partial costs associated with health care services. The costs for different types of health care related services also vary widely, depending on various factors, e.g., the amount of resource and the time of a health care professional required to provide a service to an individual, the complexity of the service provided, etc. The individual to whom the service was provided and/or her health insurance company may be charged based on the type of service provided.

Because of the numerous types of physicians, health care organizations, insurance coverage, insurance providers, as well as the numerous types of health care related services, it may be difficult to manage an efficient health care economics system.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 is an exemplary block diagram illustrating a health care economics modeling system that may be employed in a health care organization in accordance with various embodiments of the present invention.

FIG. 2 is an exemplary block diagram illustrating a rates manager in accordance with various embodiments of the present invention.

FIG. 3 is an exemplary diagram illustrating a rates manager in accordance with various embodiments of the present invention.

FIGS. 4 and 5 are exemplary diagrams illustrating an impact analyzer in accordance with various embodiments of the present invention.

FIG. 6 is an exemplary flow diagram illustrating a method for managing and analyzing rate exhibits in accordance with various embodiments of the invention.

FIG. 7 illustrates a block diagram of an example computer system that may be suitable for practicing a health care economics modeling system in accordance with various embodiments of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A and/or B” means “(A), (B), or (A and B)”. For the purposes of the present invention, the phrase “A/B” means “(A), (B), or (A and B),” similar to the phrase “A and/or B”. For the purposes of the present invention, the phrase “at least one of A, B, and C” means “(A), (B), (C), (A and B), (A and C), (B and C), or (A, B and C)”. For the purposes of the present invention, the phrase “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of the present invention provide systems and methods for generating and managing an efficient health care economics modeling system.

Various embodiments of the present invention will be described herein with respect to generating, maintaining, and managing an efficient health care economics modeling system. However, those skilled in the art will understand that the present invention may be applicable to generating, maintaining, and managing an economics model with respect to other areas as well.

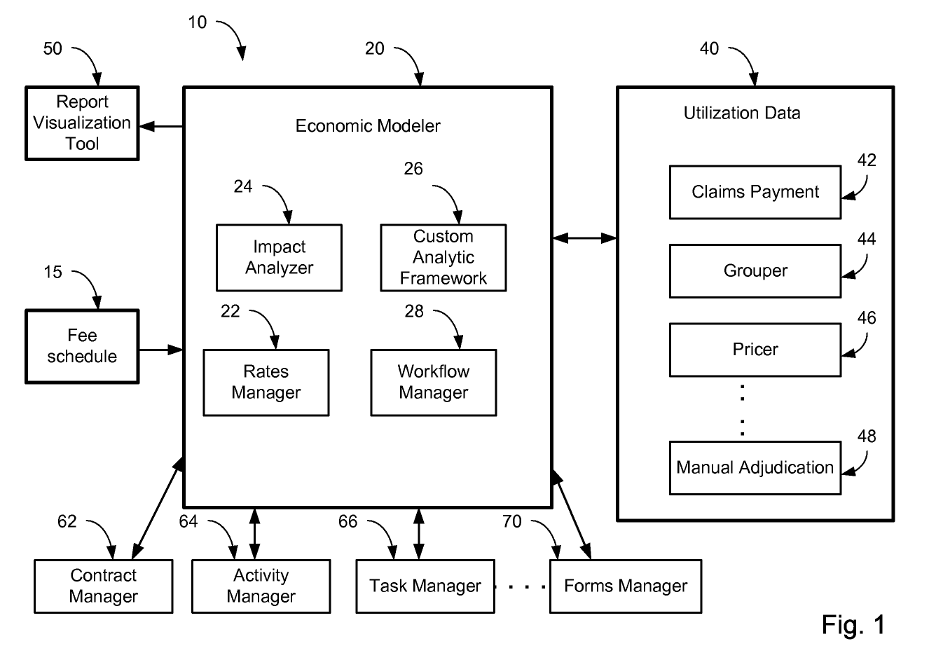

FIG. 1 is an exemplary block diagram illustrating a health care economics modeling system 10 that may be employed in a health care organization in accordance with various embodiments of the present invention. The health care organization may provide numerous health related services and may charge the patient and/or her insurance company depending on the type of service provided. The charge may depend on several factors including, but not limited to, the type and complexity of the service provided, resource(s) needed for providing the service, time spent and the qualification of the service provider, the individual's age, health condition, insurance coverage, etc. Alternatively, the health care organization may pay a service provider (e.g., a physician) for providing service to the organization.

The system 10 of FIG. 1 includes an economic modeler 20, which forms the core of the health care economics modeling system 10. Referring to FIG. 1, the economic modeler 20 is configured to receive a standardized fee schedule 15. In various embodiments, the fee schedule 15 may broadly refer to a suggested listing of fees for different types of health care related services. For example, the fee schedule 15 may specify a first fee for a routine visit to a family physician lasting for 30 minutes or less. The fee schedule 15 may specify a second fee, same or different from the first fee, for a visit lasting for 30 minutes or less to a diabetes specialist to specifically check a diabetes related disorder for a diabetic male aged more than 60 years. The fee schedule 15 may also specify a third fee for a laser eye surgery to remove cataract.

In various embodiments, various types of health care related services specified in the fee schedule may be divided into different groups, e.g., surgery, lab, radiology, routine visits, specialty visits, etc. For example, services related to X-Rays, Magnetic resonance imaging (MRI), and Computed tomography (CT) scan may be grouped together in the radiology group.

Various organizations (e.g., federal agencies, associations of health service providers, etc.) regularly publish and update standardized health care fee schedules. For example, the Center for Disease Control (CDC) and the Center for Medicare & Medicaid Services (CMS) (both federal agencies in the United States of America) publish standardized health care fee schedules. Alternatively, a health care fee schedule may be generated internally within a health care organization, provided by a health insurance company, a state government agency, and/or obtained from any other appropriate source. In various embodiments, the standardized fee schedule 15 is received from an appropriate external source and/or generated internally within the health care organization.

In various embodiments, the economic modeler 20 may also receive utilization data 40. In various embodiments, utilization data 40 is intended to broadly refer to any data associated with a plurality of health claims the health care organization generates or receives during a given period of time and/or a resource utilization of the health care organization. Generally, when the health care organization provides a health care related service to an individual, the health care organization charges the individual, her health insurance provider and/or Medicare for the service provided. In various embodiments, the term “health claim” is intended to broadly refer to any charge or price a health care organization charges to another individual/organization or receives from another individual/organization in connection with a health care related service. For example, a physician (or the associated health care organization) may submit a health claim to a patient and/or the patient's health insurance provider for a health service (e.g., a surgery) provided to the patient.

In various embodiments, the utilization data 40 may include information related to various attributes of the organization's health claims, e.g., total number of health claims submitted over a certain period of time, total claims payment 42 received, various categories or groups (e.g., surgery, lab, radiology, general visit, specialty visits, etc.) of health claims (grouper 44), etc. In various embodiments, the utilization data 40 may also include a pricer 46 which includes information about the price or cost associated with one or more health claims and a manual adjudication 48 which includes information about one or more health claims that may have been manually adjudicated (i.e., manually adjusted or settled by authorized personnel of the health care organization). The utilization data 40 may also include additional information (not shown) associated with a resource utilization of the health care organization.

In various embodiments, the economic modeler 20 may also interact with a contract manager 62. The contract manager 62 may, in various embodiments, generate and manage contracts the health care organization has with other health care organizations, health service providers, health insurance providers, physicians, and/or other individuals. For example, the health care organization may be engaged in a contract with a laboratory which provides radiology services to the health care organization, with a physician associated with the organization, and/or with a health insurance provider whom the health care organization bills regularly. In various embodiments, Choreo™ Contract Manager® provided by Kryptiq, located at Hillsboro, Oreg., may operate as the contract manager 62.

In various embodiments, the economic modeler 20 may also interact with an activity manager 64. The activity manager 64 may manage various activities related to the health care organization. Activities, in various embodiments, may refer to, for example, adding a health care provider to the health care organization, adding a new patient in a patient database, signing a new contract with a health insurance provider, etc. In various embodiments, the economic modeler 20 may also interact with a task manager 66. The task manager 66 may manage various tasks related to the health care organization. Tasks, in various embodiments, may refer to operations required to complete one or more activities. In various embodiments, the economic modeler 20 may also interact with a forms manager 70. The forms manager 70 may generate and manage various forms related to the health care organization. Forms, in various embodiments, may refer to, for example, forms related to submitting a claim, receiving a payment, grouping claims based on one or more attributes, etc. In various embodiments, the Choreo™ Publisher® provided by Kryptiq, located at Hillsboro, Oreg., may operate as the activity manager 64, task manager 66, and/or the forms manager 70. The economic modeler 20 may also interact with various other components (not shown), such as those responsible to manage various resources and financial procedures of the health care organization.

In various embodiments, the economic modeler 20 may also interact with a report visualization tool 50 used to visualize and display various reports generated by the economic modeler 20.

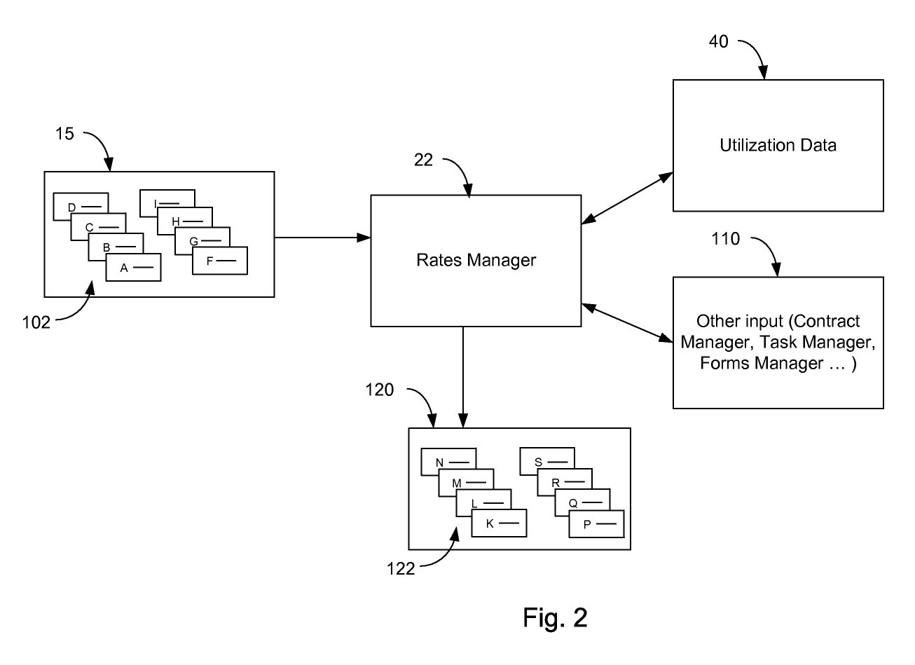

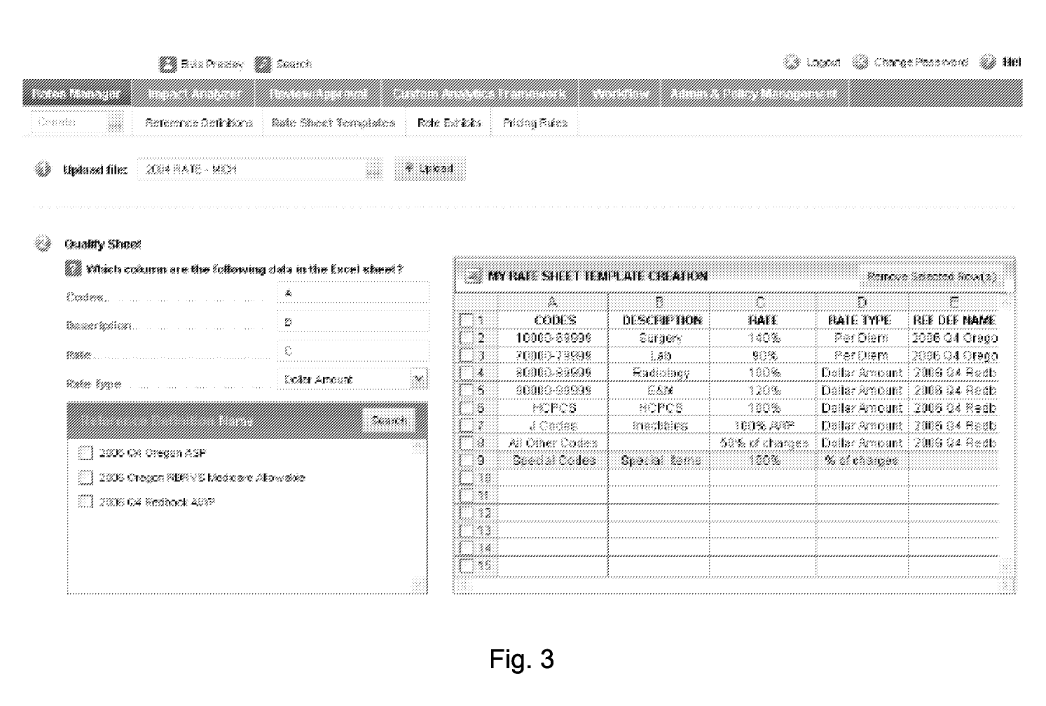

In various embodiments, the economic modeler 20 may include various software components, including a rates manager 22. FIG. 2 is an exemplary block diagram illustrating the rates manager 22 of FIG. 1 in accordance with various embodiments of the present invention. Also, FIG. 3 is an exemplary diagram illustrating the rates manager 22 in accordance with various embodiments of the present invention.

Referring to FIGS. 1 and 2, the rates manager 22 may receive the standardized fee schedule 15. The fee schedule 15 may include suggested fees 102 for a plurality of health care services. The rates manager 22 may also receive utilization data 40 and interact with various other components 110 (e.g., the contract manager 62, activity manager 64, task manager 66, and forms manager 70, etc.)

In response to the fee schedule 15, utilization data 40, and other input 110, the rates manager 22 may generate rate exhibits 120, including a plurality of rates 122. In various embodiments, the term rate exhibit may broadly refer to a summarized abstraction of the fee schedule, with additional qualifying attributes, which the health care organization intends to charge for health related services provided by the organization. For example, in various embodiments, the suggested fee in the fee schedule for a routine dermatologist visit may be $100 for a visit lasting for less than 30 minutes. The health care organization may have a contract negotiated with a health insurance provider, wherein the insurance provider may be willing to pay a maximum of $70 for the visit (including any co-payment paid by the patient). In that case, the rates in the rate exhibits 120 corresponding to the dermatologist visit would be 70% of the fees listed in the fee schedule for that particular insurance provider. In various embodiments, a fee 102 in the fee schedule 15 for a certain health related service may be multiplied by a multiplying factor (70% or 0.7 in the above example) to generate a corresponding rate 122 in the rate exhibits 120.

As discussed previously, various types of health services may be divided into a number of groups (e.g., surgery, radiology, regular office visit, etc), each group including similar types of health services. For example, services related to X-Rays, MRI, and CT scan may be grouped together in the radiology group. In various embodiments, the rates manager 22 may receive such grouping information from the grouper 44. In various embodiments, the rates manager 22 may modify the fees in the fee schedule in similar fashion for all the services in a group to generate the corresponding rates. For example, rates for all radiology services may be, say, 110% of the corresponding suggested fees for those services in the fee schedule 15. In that case, an X-Ray and a CT scan may have a rate of $110 and 330$ respectively, if the suggested fee for these services are $100 and $300, respectively, in the fee schedule 15.

The rates manager 22 may also be used to explicitly define carve outs in the fee schedule. In various embodiments, carve out may broadly refer to any exception in how the rates in the rate exhibits 120 are being generated from the fee schedule 15. For example, a plurality of surgical related services may be grouped under the surgery group. The rates manager 22 may fix the rates of all services in the surgery group to be 140% of their corresponding fees in the fee schedule. However, as an exception, the rates manager 22 may fix the rate of a caesarian operation to $8,000, irrespective of the suggested fee of a caesarian operation in the fee schedule.

In various embodiments, the rates manager 22 may also be used to adjust for inflation by increasing the rates of all items in the rate exhibits 120 in response to inflation in the economy. The rates manager 22 may also be used to adjust rates based on a geographical location of the health care organization. For example, a health care organization located in a large metropolitan area may have a higher rate in the rate exhibits 120 compared to an organization in the rural area.

In various embodiments, the rates manager 22 may also be used to define different rates in the rate exhibits 120 to be charged to different organizations. For example, for a routine physician visit, the health care organization may charge a first health insurance provider a first rate; whereas for the same service, the healthcare organization may charge a second health insurance provider a second rate, which may be the same or different from the first rate, based on various factors, e.g., contractual obligation with the insurance providers, type of insurance, etc.

In various embodiments, the economic modeler 20 may display the created rate exhibits 120 using any appropriate mechanism known to those skilled in the art. In various embodiments, the economic modeler 20 may also transmit the created rate exhibits 120 to the report visualization tool 50, which may be used to facilitate visualization of the created rate exhibits 120.

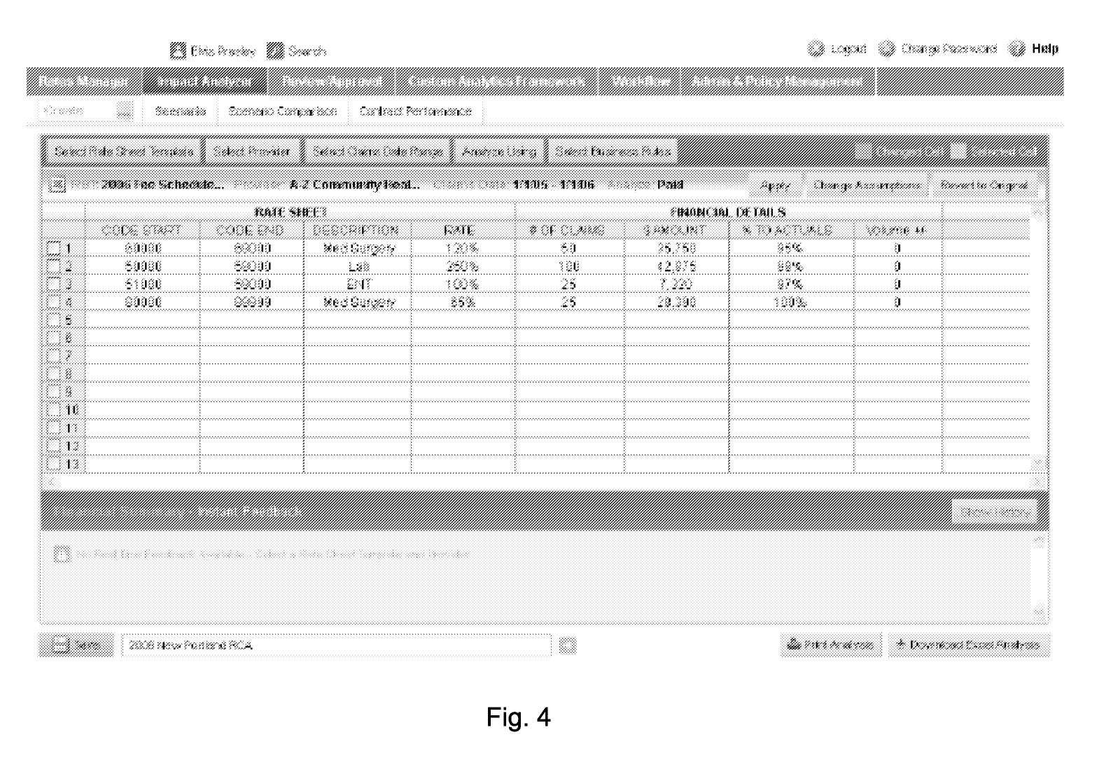

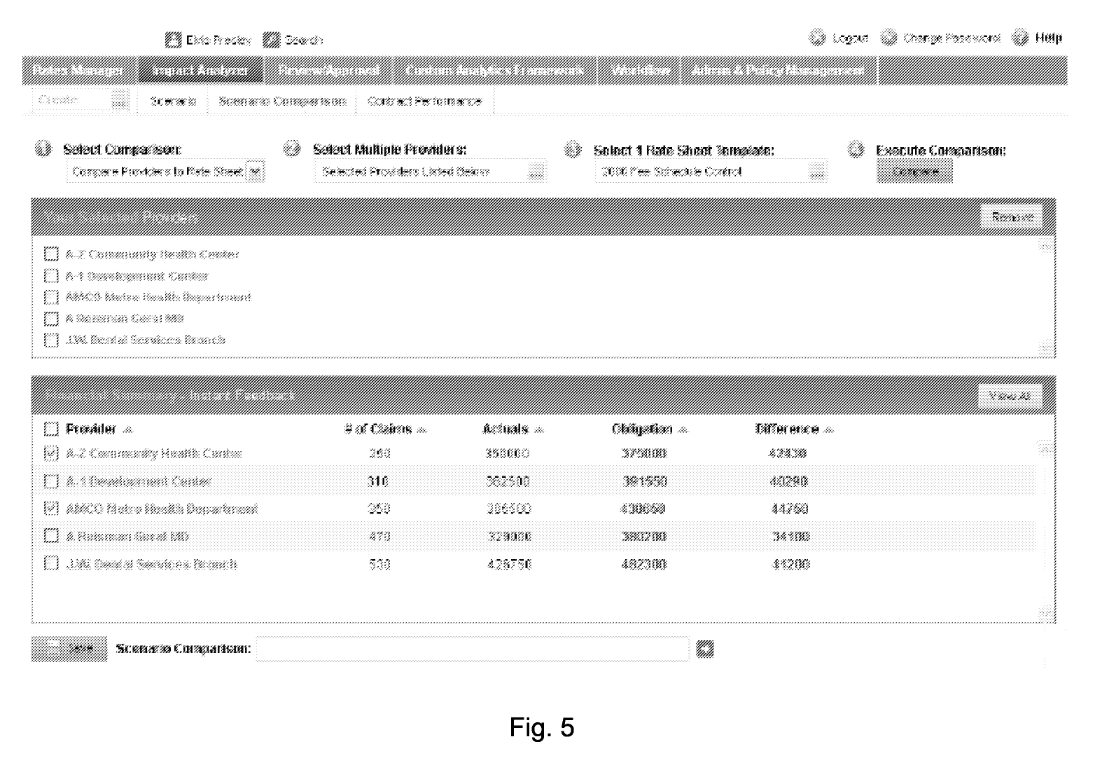

In various embodiments, the economic modeler 20 may also include an impact analyzer 24 to analyze the impact of the rates in the rate exhibits 120 on the organizational economics. FIGS. 4 and 5 are exemplary diagrams illustrating the impact analyzer 24 in accordance with various embodiments of the present invention.

The impact analyzer 24 may receive utilization data 40, including information related to a plurality of health claims, e.g., total number of health claims received, groupings of health claims, manual adjudication to the claims, prices associated to each claims, etc. In various embodiments, the impact analyzer 24 may be used to perform financial analysis of the rates in the rate exhibits 120 and forecast the impact of a variety of “what-if” scenarios. The impact analyzer 24 may, for example, analyze the effects of a change in the rate exhibits 120, a change in the fee schedule 15, or a change in the claim information on the financial situation of the health care organization. For example, in various embodiments, the impact analyzer 24 may compare the financial effects of a current rate exhibits versus a new rate exhibits based on a constant or a projected increase in the volume of claims.

Rates in the rate exhibits 120 for a given service may be different for a contracted health care organization/professional (i.e., with whom the health care organization has contractual obligation) as compared to a non-contracted health care organization/professional (i.e., with whom the health care organization does not have any contract). In various embodiments, the impact analyzer 24 may compare, using the rate exhibits 120 and utilization data, the financial effects of the providing/receiving service to/from a contracted health care organization/professional versus a non-contracted health care organization/professional.

In various embodiments, the impact analyzer 24 may display information about some or all the health claims pending with another organization (e.g. a health insurance provider) and may apply the rates in the rate exhibits 120 to the claims to calculate the total financial amount involved with those health claims.

In various embodiments, the impact analyzer 24 may perform numerous other functions including, but not limited to, generating projections/reports to be used for budgeting, comparing previously projected financial performance of the organization with the current performance, etc.

In various embodiments, the economic modeler 20 may display some or all the analysis performed by the impact analyzer 24, using any appropriate mechanism known to those skilled in the art. In various embodiments, the economic modeler 20 may also transmit some or all the analysis performed by the impact analyzer 24 to the report visualization tool, which may be used to facilitate visualization of the analysis performed.

In various embodiments, the economic modeler 20 may also include a custom analytic framework 26. Health care executives (HCE) may use the custom analytic framework 26 to create complex analysis and manage them in an integrated manner so that the HCEs can publish the right analysis to the right people inside or external to the organization. For example, the custom analytic framework 26 may interact with the contract manager 62, and analyze the effects of a change in a contractual term with another organization on the rate exhibits and perform associated financial analysis. In various embodiments, the custom analytic framework 26 may export the rate exhibits 120 and the analysis it performs to the contract manager 62, which the contract manager may use to generate one or more contracts with one or more external organizations/professionals.

In various embodiments, the economic modeler 20 may also include a workflow manager 28. In various embodiments, the term workflow may broadly refer to managing and monitoring the creation, distribution and retrieval of data related to the rate exhibits, fee schedule, claims, and/or other data and documents used in the health care organization. Health care business analyst may use the workflow manager 28 to define standardized processes for fee schedule management, volume analysis, creation and analysis of the rate exhibits, etc. For example, the organizational rules may require prior approval from a high level health care executive for changing rates for services associated with cancer. Once this information in input in the workflow manager 28, it will not allow any change in rates for cancer associated services unless the high level health care executive inputs her approval in the workflow manager 28, while allowing changes in rates for other types of services without any such approval.

In various embodiments, the workflow manager 28 may streamline workflow by defining and managing work-order forms related with one or more of activities, and/or communicating the rate exhibits 120 to other components (e.g., contracts manager 62, activity manager 64, task manager 66, forms manager 70, etc). The workflow manager 28 may also include visual tools to perform workflow management, define workflow, including standardized review and approval of workflows, view any workflow bottlenecks, facilitate work queue management, and automatically extract information from other components of the economic modeler (e.g., the rates manager 22, impact manager 24, and the custom analytic framework 26) for review.

In various embodiments, the workflow manager 28 may, optionally in conjunction with the report visualization tool, display some or all the workflow analysis performed, using any appropriate mechanism known to those skilled in the art.

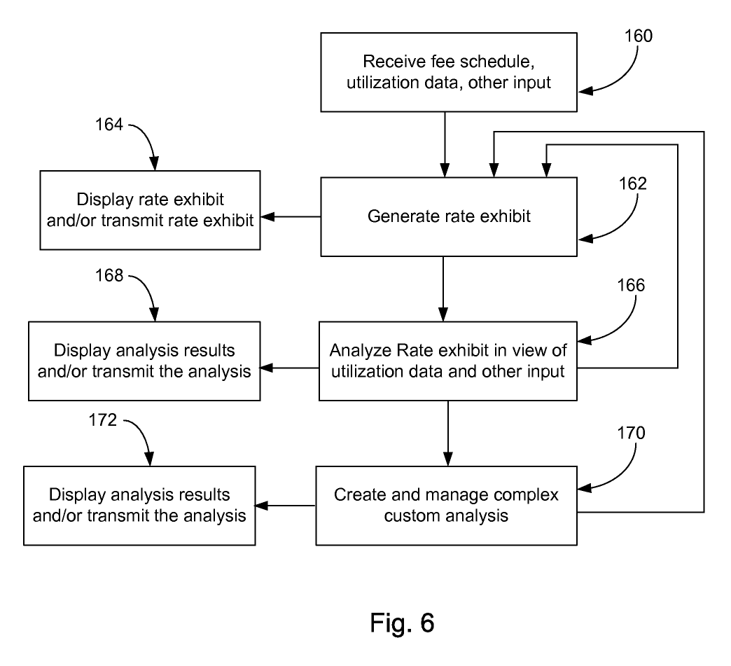

FIG. 6 is an exemplary flow diagram illustrating a method for managing and analyzing rate exhibits in accordance with various embodiments of the invention. Referring to FIGS. 1, 2, and 6, the rates manager 22 may receive fee schedule 15, utilization data 40, and/or any other appropriate input from other sources (e.g., contract manager 62, activity manager 64, etc.). At 162, the rates manager 22 may generate rate exhibits 120, including a plurality of rates 122. In various embodiments, at 164, the economic modeler 20 may optionally display the created rate exhibits 120 by itself and/or in conjunction with the report visualization tool 50. In various embodiments, the economic modeler 20 may also optionally transmit the created rate exhibits 120 to other components, e.g. contract manager 62, activity manager 64, tasks manager 66, forms manager 70, etc.

At 166, the impact analyzer 24 may analyze the created rate exhibits in view of the utilization data and/or other inputs. In various embodiments, at 168, the analysis results may be optionally displayed and/or transmitted to other components, e.g. contract manager 62, activity manager 64, tasks manager 66, forms manager 70, etc. As illustrated, the results of the analysis may also be used to generate future rates exhibits.

At 170, the custom analytic framework 26 may create and manage complex custom analysis in an integrated manner. For example, the custom analytic framework 26 may interact with the contract manager 62, and analyze the effects of a change in a contractual term with another organization on the rate exhibits and perform associated financial analysis. In various embodiments, at 172, the analysis results may be optionally displayed and/or may be transmitted to other components. For example, the analysis results may be transmitted to the contract manager 62, which the contract manager may use to generate one or more contracts with one or more external organizations/professionals. As illustrated, the results of the analysis may also be used to generate future rates exhibit. Although now shown in FIG. 6, in various embodiments, the workflow manager 28 may be used to define standardized processes for rate exhibits creation, management, and analysis.

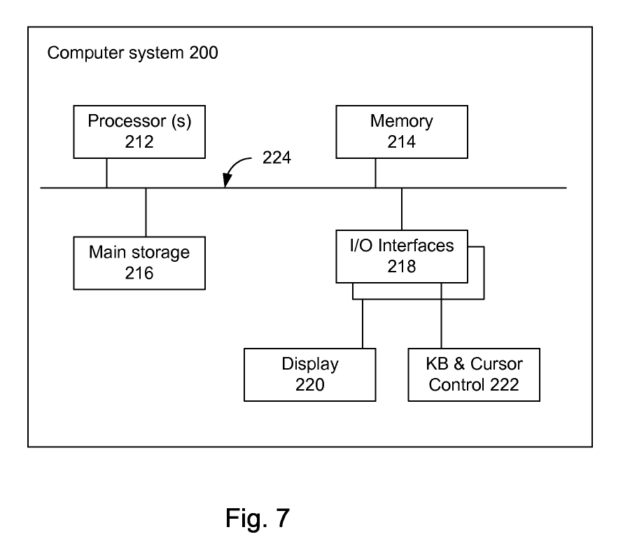

FIG. 7 illustrates a block diagram of an example computer system 200 that may be suitable for practicing a health care economics modeling system 10 in accordance with various embodiments of the present invention. As illustrated, the computer system 200 includes one or more digital computing processor(s) 212 and memory 214 coupled to each other via bus 224. Further, computer system 200 includes mass storage device 216, I/O interfaces 218, and a number of I/O devices coupled to each other and the earlier described elements as shown. In various embodiments, memory 214 and/or mass storage device 216 may include some or all the components of the health care economics modeling system 10. In various embodiments, some of the components of the health care system 10 may also be included in a different computer system, accessible to the computer system 200. In various embodiments, I/O interfaces 218 include a communication interface for coupling the computer system 200 to other computer systems in which some of the components of the health care economics modeling system 10 may be included. The communication interface may be wire based or wireless, used to couple the computer system 200 to a network, e.g. a wired/wireless local/wide area network. An example of a suitable wired network interface includes, but is not limited to, an Ethernet interface, and an example of a suitable wireless network interface includes, but is not limited to, an IEEE 802.11b (working group) network interface. The I/O devices include in particular, display 220 and keyboard/cursor control 222.

In various embodiments, processor 212 may be any one of a number of microprocessors known in the art, or to be designed (as long as they are consistent with the teachings of the present invention), including but are not limited to, the processors available from Intel Corp.®, of Santa Clara, Calif. Memory 214 may likewise be any one of a number of volatile storage known in the art or to be designed (as long as they are consistent with the teachings of the present invention), including but are not limited to, the volatile storage available from Kingston Technology® of Fountain Valley, Calif. Mass storage device 216 may likewise be any one of a number of non-volatile storage known in the art or to be designed (as long as they are consistent with the teachings of the present invention), including but are not limited to, the non-volatile disk storage available from Seagate of Scotts Valley®, Calif.

Each of the elements of this figure represents a broad range of the corresponding element known in the art or to be designed, consistent with the teachings of the present invention. The elements perform their conventional functions, i.e. processing, storing, reading, displaying, and so forth. In various embodiments, health care economics modeling system 10 may be a single or a plurality of processes, executed as a single thread or multiple threads, on a single or multiple processors.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

1. A method of electronically managing health care rate exhibits, the method comprising:
receiving, by a health care administration application, standardized fee schedules for a plurality of health related services; and
creating in response, by the health care administration application, rate exhibits from the received standardized fee schedule.

2. The method of claim 1, further comprising:
receiving, by the health care administration application, utilization data including data related to a plurality of health claims; and
analyzing, by the health care administration application, the created rate exhibits in view of the received utilization data.

3. The method of claim 1, wherein said receiving of standardized fee schedules comprises receiving schedules of suggested fees for the plurality of health related services.

4. The method of claim 1, wherein said creating of rate exhibits comprises creating a schedule of rates for the plurality of health related services which a health care organization intends to charge.

5. The method of claim 2, further comprising:
multiplying, by the health care administration application, a fee in the standardized fee schedule with a multiplying factor to create a corresponding rate in the rate exhibits.

6. The method of claim 1, further comprising:
defining, by the health care administration application, carve outs in the rate exhibits.

7. The method of claim 2, wherein said analyzing of the created rate exhibits further comprises:
selecting, by the health care administration application, a rate from the created rate exhibits; and
applying, by the health care administration application, the selected rate to one or more corresponding health claims from the plurality of health claims, thereby analyzing the impact of the rate on the one or more health claims.

8. The method of claim 5, further comprising:
grouping, by the health care administration application, the plurality of health claims in one or more groups of health claims; and
applying, by the health care administration application, the same multiplying factor to more than one health claims in the same group.

9. The method of claim 2, further comprising:
transmitting, by the health care administration application, the results of the analysis of the created rate exhibits to a report visualization tool for visualizing the analysis.

10. The method of claim 2, further comprising:
transmitting, by the health care administration application, the rate exhibits and/or the results of the analysis to a contract manager to generate new contracts based on the transmission.

11. The method of claim 2, further comprising:
facilitating a health care administrator, by the health care administration application, in defining standardized process for creation and analysis of rate exhibits.

12. A system for electronically managing rate exhibits for a health care provider, the system comprising:
one or more storage devices including one more databases adapted to store data; and
one or more servers operatively coupled to the one or more storage devices, the one or more servers being configured to receive standardized fee schedules for a plurality of health related services, and the one or more servers being further configured to create rate exhibits for the plurality of health related services from the received standardized fee schedule.

13. The system of claim 12, the one or more servers being further configured to:
receive utilization data including data related to a plurality of health claims; and
analyze the created rate exhibits in view of the received utilization data.

14. The system of claim 12, the one or more servers being further configured to:
multiply a fee in the standardized fee schedule with a multiplying factor to create a corresponding rate in the rate exhibits.

15. The system of claim 12, the one or more servers being further configured to:
select a rate from the created rate exhibits; and
apply the selected rate to one or more corresponding health claims from the plurality of health claims, thereby analyzing the impact of the rate on the one or more health claims.

16. The system of claim 12, the one or more servers being further configured to:
transmit the rate exhibits and/or the results of the analysis to a contract manager to generate new contracts based on the transmission.

17. An article of manufacture comprising:
a storage medium; and
a plurality of instructions stored therein;
wherein the plurality of instructions are adapted to cause one or more processors to perform a plurality of health care rate exhibits operations, the plurality of operations comprising:
receiving standardized fee schedules for a plurality of health related services; and
creating rate exhibits from the received standardized fee schedule.

18. The article of manufacture of claim 17, the plurality of operations further comprising:
receiving utilization data including data related to a plurality of health claims; and
analyzing the created rate exhibits in view of the received utilization data.

19. The article of manufacture of claim 17, the plurality of operations further comprising:
selecting a rate from the created rate exhibits; and
applying the selected rate to one or more corresponding health claims from the plurality of health claims, thereby analyzing the impact of the rate on the one or more health claims.

20. The article of manufacture of claim 17, the plurality of operations further comprising:
facilitating a health care administrator in defining standardized process for creation and analysis of rate exhibits.
